(19) United States
(12) Patent Application Publication
(10) Pub. No.: US 2010/0238792 A1
(43) Pub. Date: Sep. 23, 2010

(54) INFORMATION ACQUISITION SYSTEM, TRANSMIT APPARATUS, DATA OBTAINING APPARATUS, TRANSMISSION METHOD, AND DATA OBTAINING METHOD

(75) Inventor: Tsutomu Togo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 12/714,667

(22) Filed: Mar. 1, 2010

(30) Foreign Application Priority Data
Mar. 19, 2009 (JP) 2009-69106

(51) Int. Cl. H04J 1/16; H04L 12/26; H04N 7/173

(52) U.S. Cl. 370/216; 370/241; 725/109

(57) ABSTRACT

A data obtaining apparatus includes an obtaining section configured to obtain data units from data transmitted from a transmit apparatus through a network, including a first data containing video or audio data and a second data containing quality influence information of the first data, a determination section configured to determine whether the first data has been lost during transmission, a detection section configured to detect, when the first data has been lost, the second data transmitted before the lost first data and the second data transmitted after the lost first data, from the obtained data units, and an extraction section configured to extract the quality influence information from the detected second data. And, an information acquisition system including the data obtaining apparatus and the transmit apparatus is provided.

### CROSS-REFERENCE TO RELATED APPLICATIONS

This application is based upon and claims the benefit of priority from the prior Japanese Patent Application No. 2009-69106 filed on Mar. 19, 2009, the entire contents of which are incorporated herein by reference.

### BACKGROUND

1. Field

Embodiments described herein relate to an information acquisition system, a transmit apparatus, a data obtaining apparatus, a transmission method, and a data obtaining method.

2. Description of the Related Art

In recent years, the distribution of high-definition video through a network such as the Internet has been actively performed, as in an IPTV (Internet Protocol TeleVision) and an Internet television, for example. Normally, in such video distribution, video data and audio data are packetized by a server and multiplexed and transmitted as video packets and audio packets, respectively. These video packets and audio packets are transmitted through the network and received by a user terminal such as a television and a personal computer possessed by a user, for example. The video packets and audio packets are then subjected to processing such as decoding by the user terminal. Thereby, video and audio are reproduced.

In this case, if a packet loss occurs in the network, for example, some of the packets fail to be received by the user terminal. As a result, the reproduced video and audio are deteriorated in image quality and sound quality. Therefore, to understand the quality of a service provided to users by a business entity which distributes video, for example, it is important to accurately estimate the quality of the video and audio reproduced by the user terminal, including the deterioration of the image quality and sound quality due to the packet loss. In view of this, a method has been discussed which previously stores, in each video packet, the information of the frame type and the frame generation rule of the video data stored in the video packet, and which estimates, in the event of a packet loss, the quality of the reproduced video on the basis of the information of the frame type and the frame generation rule. That is, when a packet loss occurs in a network, the quality of the video reproduced by a user terminal is estimated on the basis of the information of the frame type and the frame generation rule stored in the video packet transmitted before the lost video packet and the video packet transmitted after the lost video packet.

### SUMMARY

It is an aspect of the embodiments discussed herein to provide an information acquisition system and method.

The above aspects can be attained by a system that includes a transmit apparatus, a data obtaining apparatus, and method thereof.

The transmit apparatus includes a first generation section configured to generate a first data containing video or audio data, a second generation section configured to generate a second data containing quality influence information of the first data, and a transmit section configured to transmit the first and second data to a network.

The data obtaining apparatus includes an obtaining section configured to obtain data transmitted through the network, a determination section configured to determine whether or not the first data has been lost during the transmission thereof, a detection section configured to detect, if it is determined that the first data has been lost, the second data transmitted before the lost first data and the second data transmitted after the lost first data, from the obtained data units, and an extraction section configured to extract the quality influence information from the detected second data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an example of a network configuration;

FIG. 2 illustrates a configuration example of a video audio transmit apparatus;

FIG. 3 illustrates an example of a packet format;

FIG. 4 illustrates an example of quality influence information;

FIG. 5 illustrates an example of a null packet;

FIG. 6 illustrates a configuration of a packet obtaining apparatus;

FIG. 7 is a flowchart illustrating an operation example of the video audio transmit apparatus;

FIG. 8 is a diagram illustrating a specific example of packet generation;

FIG. 9 illustrates an example of a higher-level packet format;

FIG. 10 is a flowchart illustrating an operation example of the packet obtaining apparatus;

FIG. 11 illustrates an example of packet arrangement;

FIGS. 12A and 12B are diagrams for explaining an example of extraction of quality influence information;

FIG. 13 illustrates a configuration example of another video audio transmit apparatus;

FIG. 14 illustrates another example of the quality influence information;

FIG. 15 illustrates another example of the null packet;

FIG. 16 is a flowchart illustrating another operation example of the video audio transmit apparatus;

FIG. 17 illustrates another example of the packet arrangement;

FIGS. 18A and 18B are diagrams for explaining another example of the extraction of the quality influence information;

FIG. 19 illustrates another configuration example of the video audio transmit apparatus;

FIG. 20 illustrates another example of the null packet;

FIG. 21 illustrates another example of the packet arrangement; and

FIG. 22 illustrates another example of the packet arrangement.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Embodiments of an information acquisition system, a transmit apparatus, a data obtaining apparatus, a transmission method, and a data obtaining method disclosed in the present application will be described in detail below with reference to the drawings. The present invention is not limited by the embodiments.

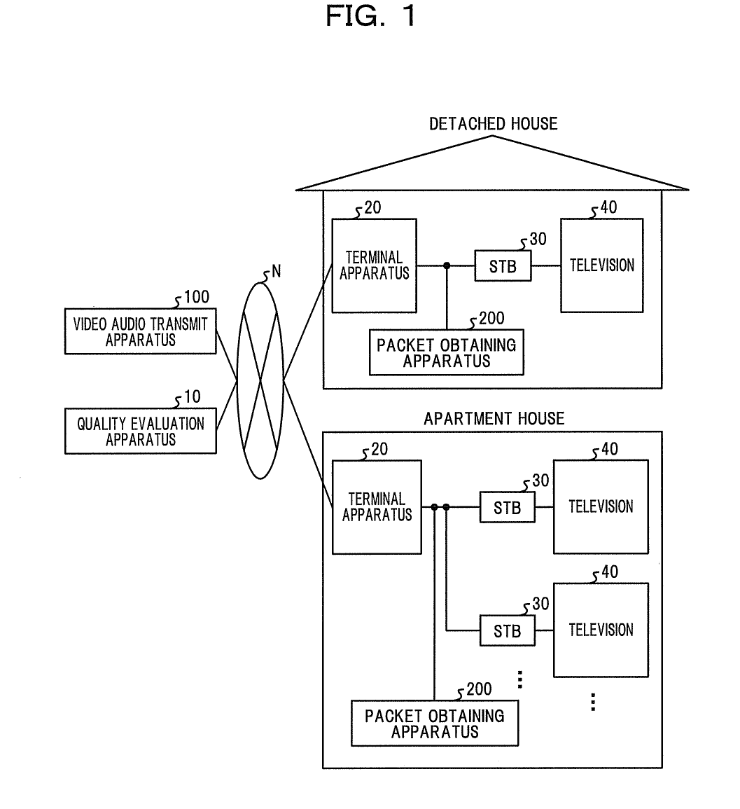

FIG. 1 illustrates an example of a network configuration according to an embodiment. As illustrated in FIG. 1, in the network configuration of the present embodiment, a video audio transmit apparatus 100, a quality evaluation apparatus 10, and terminal apparatuses 20 are connected via a network N. Further, in a detached house and an apartment house, the terminal apparatus 20 is connected to a television 40 via an STB (Set-Top Box) 30 for each dwelling unit. Further, a packet obtaining apparatus 200 is provided between the terminal apparatus 20 and the STB 30.

The video audio transmit apparatus 100 is connected to the network N. The video audio transmit apparatus 100 transmits video packets and audio packets to the terminal apparatus 20 in each house through the network N. Further, to maintain a constant transmission rate, the video audio transmit apparatus 100 multiplexes the video packets and the audio packets with null packets not containing video and audio data, and transmits the multiplexed packets. A null packet does not contain data affecting the reproduction by a receiving terminal, and is discarded after being received by the receiving terminal. The video audio transmit apparatus 100 inserts, in each null packet, quality influence information representing a degree by which the data of the video packet transmitted immediately before the null packet and the video packet transmitted immediately after the null packet affects the reproduction quality of the entire video, and then transmits the null packet. That is, quality influence parameters affecting the reproduction quality, such as a frame number corresponding to each video packet and the reproduction importance representing the importance of the video packet in the reproduction process, for example, are stored in a null packet as the quality influence information. A specific configuration and operation of the video audio transmit apparatus 100 will be described in detail below. While particular parameters affecting reproduction quality are described herein, the present invention is not limited to any particular parameter.

The terminal apparatus 20 is connected to the network N. The terminal apparatus 20 performs conversion between the signal format used in the network N and the signal format used in each house. For example, the terminal apparatus 20 performs mutual conversion between optical signals in the network N and electrical signals in a house. Then, after the convention of the signal format, the terminal apparatus 20 outputs the video packets and the audio packets to the STB 30 in each dwelling unit.

The STB 30 decodes the video packets and the audio packets as necessary to convert the packets into signals in a format processable by the television 40. The television 40 processes the signals converted by the STB 30, to thereby reproduce video and audio. In the reproduction of the video and audio, the null packets not containing video and audio data are ignored and discarded.

The packet obtaining apparatus 200 obtains the video packets and the audio packets output from the terminal apparatus 20 to the STB 30, and detects a packet loss occurring in the network N. Further, upon detection of the packet loss, the packet obtaining apparatus 200 acquires the quality influence information from the null packet transmitted before the lost video packet and the null packet transmitted after the lost video packet from the video audio transmit apparatus 100, and transmits the acquired quality influence information to the quality evaluation apparatus 10 through the network N. As illustrated in FIG. 1, the packet obtaining apparatus 200 is provided in the vicinity of the STB 30 and the television 40, with which the reproduction of video is performed by a user. Therefore, the packet obtaining apparatus 200 is capable of obtaining video packets and audio packets substantially equal in amount to the video packets and audio packets viewed and listened to by the user. Accordingly, when the reproduction quality of the video and audio in the television 40 is affected by the packet loss, the packet obtaining apparatus 200 detects a packet loss substantially equivalent to the packet loss affecting the reproduction quality, and transmits the quality influence information relating to the lost video packet to the quality evaluation apparatus 10. A specific configuration and operation of the packet obtaining apparatus 200 is described in detail below.

With reference to the quality influence information transmitted from the packet obtaining apparatus 200, the quality evaluation apparatus 10 estimates the influence of the loss of the video packet on the reproduction quality of the video, and evaluates the quality of the video and audio reproduced by the television 40. For example, if the picture type corresponding to the lost video packet is the I-picture (Intra Picture), which serves as a reference in the decoding of another frame, the quality evaluation apparatus 10 evaluates the deterioration of the video quality to be relatively substantial. Further, if the picture type corresponding to the lost video packet is the P-picture (Predictive Picture), which is decoded with reference to the I-picture, for example, the quality evaluation apparatus 10 evaluates the deterioration of the video quality to be relatively minor. The evaluation of the video quality by the quality evaluation apparatus 10 is not limited to the above-described evaluation, but is performed on the basis of comprehensive evaluation of various items included in the quality influence information.

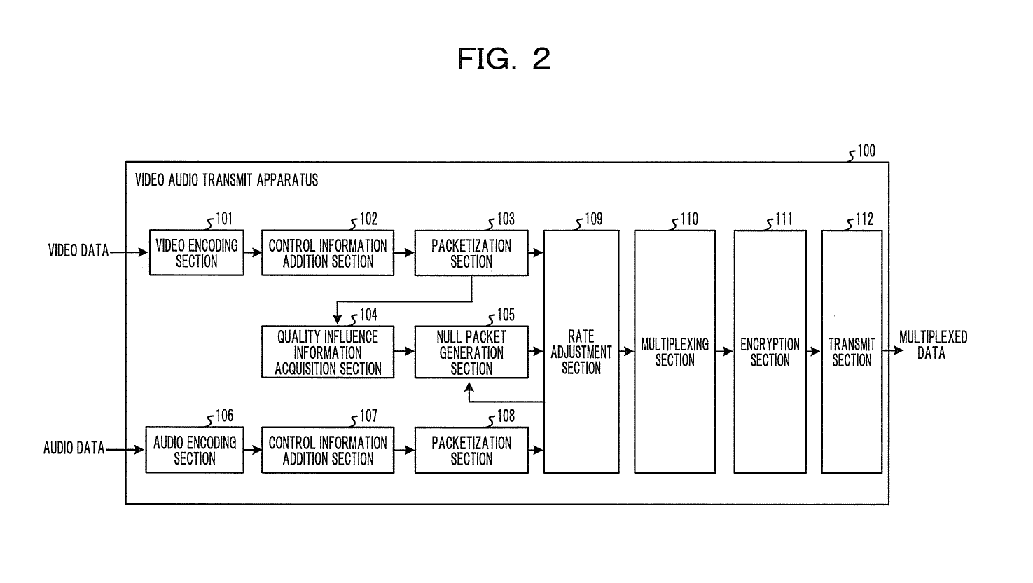

FIG. 2 illustrates a configuration of the video audio transmit apparatus 100 according to an embodiment. The video audio transmit apparatus 100 illustrated in FIG. 2 includes a video encoding section 101, a control information addition section 102, a packetization section 103, a quality influence information acquisition section 104, a null packet generation section 105, an audio encoding section 106, a control information addition section 107, a packetization section 108, a rate adjustment section 109, a multiplexing section 110, an encryption section 111, and a transmit section 112.

The video encoding section 101 encodes video data on a frame-by-frame basis with an optimal quantization operation, and outputs the obtained coded data for the respective frames to the control information addition section 102. In this process, the video encoding section 101 encodes the image of each frame in one of the picture types of the I-picture, the P-picture, and the B-picture (Bi-directional Picture). In the I-picture, which refers to an intra-frame coded image, the complete image information of the entire frame is coded. In the P-picture, which refers to an inter-frame forward prediction coded image, the information of the difference from the preceding I-picture is coded. In the B-picture, which refers to a bidirectional prediction coded image, the information of the difference from the preceding I-picture or P-picture and the difference from the following I-picture or P-picture is coded. Therefore, the I-picture is singly decodable, while the P-picture and the B-picture are not decoded unless an I-picture or P-picture serving as a reference is present.

The control information addition section 102 adds control information, such as the time stamp representing the reproduction timing of a frame, to the head of the encoded data of each frame. Then, the control information addition section 102 outputs the encoded data added with the control information to the packetization section 103.

The packetization section 103 adds header information to the encoded data to form a video packet having a fixed length. That is, the packetization section 103 adds header information, such as the synchronization byte, the packet ID (IDentifier), and the continuity counter, for example, to the encoded data added with the control information, to thereby generate a video packet having a fixed size. In the following, a portion containing the encoded data will be referred to as the data portion of the packet, and a portion containing the header information will be referred to as the header portion of the packet. Further, each of the audio packets and the null packets also includes the data portion and the header portion, and uses a packet format similar to the packet format of the video packets generated by the packetization section 103.

After the generation of the video packets by the packetization section 103, the quality influence information acquisition section 104 acquires the quality influence information representing the influence of each of the generated video packets on the reproduction quality of the entire video. For example, the quality influence information acquisition section 104 acquires, as the quality influence information of each video packet, the quality influence parameters affecting the reproduction quality, such as the frame number of the frame corresponding to the video packet and an indictor of the reproduction importance representing the importance of the video packet in the reproduction process. Among the quality influence parameters presented here as examples, the frame number indicates which one of the frames forming the entire video has the reproduction quality thereof affected by the corresponding video packet. Further, the reproduction importance indicates whether or not the video packet affects the decoding of another frame, and represents the degree of the influence of the video packet on the reproduction quality. As described below, other examples of the quality influence parameters include, for example, the position information indicating which position in a frame corresponds to the image of the encoded data contained in the video packet.

When notified by the rate adjustment section 109 that a null packet is to be inserted to correct the transmission rate, the null packet generation section 105 acquires from the quality influence information acquisition section 104 the quality influence information of the video packet located immediately before the null packet and the video packet located immediately after the null packet. Then, the null packet generation section 105 forms the null packet by adding the header information, such as the packet ID indicating that the corresponding packet is the null packet, to the acquired quality influence information, and outputs the formed null packet to the rate adjustment section 109. That is, the null packet generation section 105 generates a null packet, the data portion of which stores the quality influence information of two video packets respectively located immediately before and immediately after the null packet, and the header portion of which stores the packet ID and so forth. In this process, the null packet generation section 105 does not store data such as video or audio in the data portion of the null packet.

The audio encoding section 106 encodes audio data on a frame-by-frame basis, and outputs the obtained coded data for the respective frames to the control information addition section 107. The control information addition section 107 adds control information, such as the time stamp representing the reproduction timing of a frame, to the encoded data of each frame. Then, the control information addition section 107 outputs the encoded data added with the control information to the packetization section 108. The time stamp included in the control information is used to equalize the reproduction timing between video and audio. With the reproduction timing of the encoded data controlled in accordance with the time stamp, video and audio are reproduced in synchronization with each other.

The packetization section 108 adds header information to the encoded data to form an audio packet having a fixed length. That is, the packetization section 108 adds header information similar to the header information of the video packet to the encoded data added with the control information, to thereby generate an audio packet having a fixed size. Unlike the packetization section 103, the packetization section 108 stores, in the header portion of the audio packet, the packet ID indicating that the packet type is the audio packet.

The rate adjustment section 109 performs adjustment processing to maintain a constant transmission rate of the video packets generated by the packetization section 103 and the audio packets generated by the packetization section 108. That is, the rate adjustment section 109 determines the packet arrangement in the multiplexing of the video packets and the audio packets, and determines as necessary the insertion position of each null packet to correct the transmission rate. For example, when video and audio are close to each other in reproduction timing, the rate adjustment section 109 determines the insertion position of the null packet such that the video packets and the audio packets containing the encoded data of the video and the encoded data of the audio, respectively, are transmitted without a substantial time difference.

Further, after the determination of the insertion position of the null packet, the rate adjustment section 109 specifies the video packet located immediately before the null packet and the video packet located immediately after the null packet. Then, the rate adjustment section 109 notifies the null packet generation section 105 of the video packet located immediately before the null packet and the video packet located immediately after the null packet, together with the information that the null packet is to be inserted. As described above, on the basis of this notification, the null packet generation section 105 generates a null packet storing the quality influence information of the video packet located immediately before the null packet and the video packet located immediately after the null packet. Herein, the video packet located immediately before the null packet and the video packet located immediately after the null packet may not necessarily be located adjacent to the null packet. For example, when an audio packet is located between a null packet and a video packet, the video packet is viewed as the video packet located immediately before or immediately after the null packet.

The rate adjustment section 109 outputs the video packets, the audio packets, and the null packets to the multiplexing section 110, and notifies the multiplexing section 110 of the packet arrangement determined for these packets.

In accordance with the packet arrangement notified by the rate adjustment section 109, the multiplexing section 110 performs time-division multiplexing on the video packets, the audio packets, and the null packets. Then, the multiplexing section 110 outputs a packet train obtained by the time-division multiplexing to the encryption section 111.

The encryption section 111 encrypts the respective data portions of the video packets and the audio packets included in the packet train output from the multiplexing section 110. That is, the encryption section 111 encrypts data required in the reproduction of video to prevent unauthorized reproduction and alternation of video and audio by a third party other than a contract user. Meanwhile, the data portion of each null packet does not contain video and audio data. Therefore, the encryption section 111 does not encrypt the data portion of the null packet. Further, the packet ID stored in the header portion of each packet is used to determine the packet type. Therefore, the encryption section 111 does not encrypt the respective header portions of the video packets, the audio packets, and the null packets.

The transmit section 112 divides the packets encrypted by the encryption section 111 into groups each including a predetermined number of packets, and adds a header portion corresponding to a higher layer to each of the groups to generate packets of the higher layer (hereinafter referred to as “higher-level packets”). In this process, the transmit section 112 stores, in the header portion of each higher-level packet, the sequence number representing the serial number of the higher-level packet. As described below, the sequence number is used by the packet obtaining apparatus 200 to detect the packet loss. Then, the transmit section 112 transmits the generated higher-level packets as multiplexed data including multiplexed video and audio.

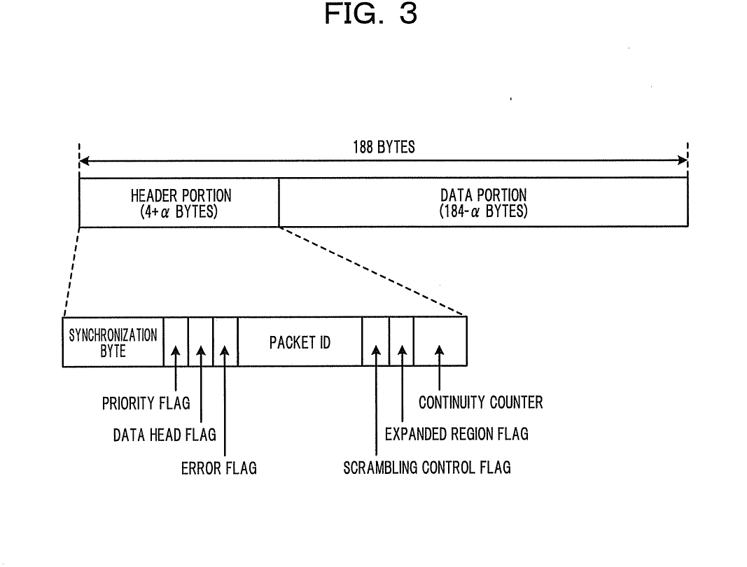

Subsequently, description will be made of the packet format of the video packets, the audio packets, and the null packets generated by the packetization section 103, the packetization section 108, and the null packet generation section 105, respectively. FIG. 3 illustrates an example of a packet format according to an embodiment. The packet illustrated in FIG. 3 is a unit of data having a fixed size of 188 bytes, which basically includes a header portion of 4 bytes and a data portion of 184 bytes. In some cases, additional information is stored in the header portion. In such a case, the size of the header portion is expanded by a bytes. Even if the header portion is expanded, the data portion is reduced by a bytes. Accordingly, the size of the packet as a whole is fixed to 188 bytes.

The header portion of the packet includes fields such as the synchronization byte, the packet ID, and the continuity counter, for example. The synchronization byte is formed by a predetermined bit string, and serves as an indicator specifying the head position of the packet. The packet ID represents the packet type, indicating whether the packet is the video packet containing video data, the audio packet containing audio data, or the null packet containing neither of the video data and the audio data. The continuity counter sequentially stores, for example, numbers 0 to 15 separately for each of the packet types, and represents the continuity of the encoded data of each of video and audio.

Further, the header portion includes a variety of flags representing the state of the packet. For example, the header portion includes a priority flag, a data head flag, an error flag, a scrambling control flag, and an expanded region flag. The priority flag indicates whether or not the packet should be decoded in preference to other packets. The data head flag indicates whether or not the packet contains the encoded data of the head of a set of data, such as one frame of data, for example. The error flag indicates whether or not an error has occurred in the packet. The scrambling control flag indicates whether or not the data portion of the packet is encrypted. The expanded region flag indicates whether or not the header portion of the packet is expanded.

The data portion of each video packet and the data portion of each audio packet store the encoded video data and the encoded audio data, respectively, with the encoded data divided into segments each having an appropriate size. That is, the data portion of each video or audio packet basically stores 184 bytes of encoded data. Meanwhile, the data portion of each null packet stores the quality influence information of the video packet located immediately before the null packet and the video packet located immediately after the null packet. Generally, the size of the quality influence information is smaller than the size of the data portion. Therefore, one quality influence information item is not divided to be stored in the respective data portions of a plurality of null packets. The size and format of the packet are not limited to those illustrated in FIG. 3. Preferably, however, the header portion of the packet stores the packet type indicating that the packet is the video packet, the audio packet, or the null packet.

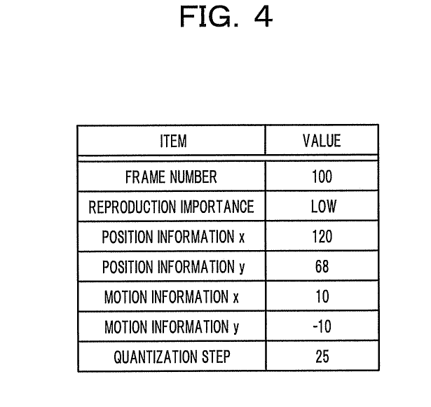

Subsequently, description will be made of an example of the quality influence information stored in the data portion of the null packet. FIG. 4 illustrates an example of the individual quality influence parameters included in the quality influence information. The quality influence information acquisition section 104 acquires the frame number, the reproduction importance, the position information, the motion information, and the quantization operation of the encoded data contained in each video packet, as the quality influence parameters of the video packet. These quality influence parameters affect the reproduction quality of the entire video.

The frame number represents the serial number assigned to each frame, and indicates which one of the frames forming the entire video has the video, the reproduction quality of which is affected by the video packet. For example, a video packet having a frame number 100 affects the reproduction quality of the video near the hundredth frame of the entire video. The reproduction importance indicates whether or not the video packet contains the encoded data affecting the decoding of the image of another frame. For example, if the picture type is the I-picture or P-picture, the picture type affects the reproduction quality of video including another frame, and thus the reproduction importance of the I-picture and the P-picture is high. Meanwhile, if the picture type is the B-picture, the picture type does not substantially affect the reproduction quality of video including another frame, and thus the reproduction importance of the B-picture is low. In the event of a packet loss, therefore, if the lost packet is a video packet having high reproduction importance (corresponding to the I-picture or P-picture), the deterioration of the video reproduction quality is relatively substantial. Meanwhile, if the lost packet is a video packet having low reproduction importance (corresponding to the B-picture), the deterioration of the video reproduction quality is relatively minor.

The position information indicates which position in a frame corresponds to the image serving as a basis for the encoded data contained in the video packet. For example, two-dimensional coordinates (X and Y coordinates) in the image of a frame are defined in units of macroblocks each formed by a predetermined number of pixels (e.g., 16 by 16 pixels), and the coordinate values of the macroblock corresponding to the video packet represent the position information. In general, in the encoding of an image, compression is performed in the up-to-down and left-to-right directions in units of macroblocks in a screen. In the event of a packet loss, therefore, if the lost packet is a video packet corresponding to the macroblock of an upper-left portion of the image, the deterioration of the video reproduction quality is relatively substantial. Meanwhile, if the lost packet is a video packet corresponding to the macroblock of a lower-right portion of the image, the deterioration of the video reproduction quality is relatively minor.

The motion information represents the moving distance by which a portion including the image serving as the basis for the encoded data contained in the video packet has moved from the I-picture or P-picture serving as a reference. For example, the motion vector of a portion of video corresponding to the video packet represents the motion information. In general, in a portion of video with a small motion amount, a minute change other than the motion stands out. Meanwhile, in a portion of video with a large motion amount, some change occurring at the same time as the motion does not substantially stand out. In the event of a packet loss, therefore, if the lost packet is a video packet corresponding to a portion with a small motion, the deterioration of the video reproduction quality is relatively substantial. Meanwhile, if the lost packet is a video packet corresponding to a portion with a large motion, the deterioration of the video reproduction quality is relatively minor.

The quantization operation refers to the quantization operation used in the encoding of the image of a frame by the video encoding section 101. For example, the video encoding section 101 encodes video data on a frame-by-frame basis with an optimal quantization operation. Therefore, the quantization operations for the encoded data items contained in the respective video packets are not necessarily the same. In general, the quantization operation represents a range of pixel values converged to the same value by encoding. If the data amount of one frame of encoded data is limited, the quantization operation is closely related to the complexity of the image of a frame. That is, the quantization operation reflects the simplicity or complexity of the image of a frame, and is closely related to the video reproduction quality. The quality influence information is not limited only to the quality influence parameters illustrated in FIG. 4, and may include other quality influence parameters affecting the reproduction quality of the entire video.

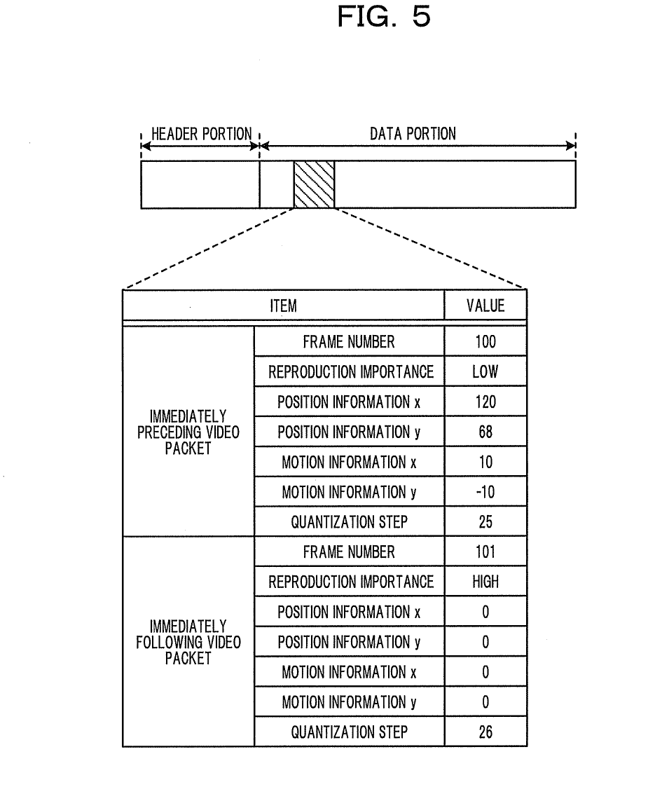

Subsequently, a configuration of the null packet generated by the null packet generation section 105 will be described. As illustrated in FIG. 5, for example, the null packet generation section 105 stores, in the data portion, the quality influence information of both the video packet located immediately before the null packet and the video packet located immediately after the null packet. In this process, the null packet generation section 105 does not store video or audio data in the data portion.

Generally, the size of the quality influence information of two video packets is smaller than the size of the data portion. Thus, the data portion of the null packet has extra space. Therefore, the null packet generation section 105 may generate the null packet such that a value “1,” for example, is stored in the respective bits of a region of the data portion other than the region storing the quality influence information. That is, if the quality influence information is stored in the region hatched with diagonal lines in FIG. 5, the null packet generation section 105 may store a meaningless bit string in a region of the data portion other than the hatched region. Further, the null packet generation section 105 stores, in the header portion, the packet ID indicating that the packet is the null packet.

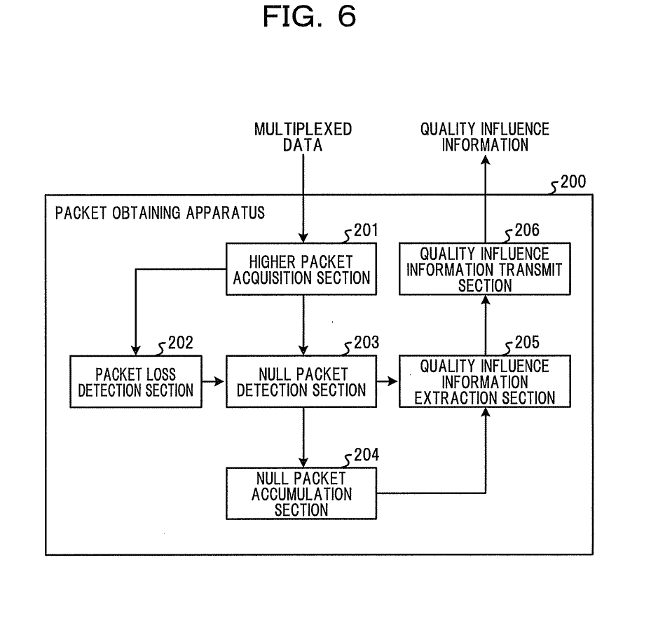

FIG. 6 illustrates a configuration of the packet obtaining apparatus 200 according to an embodiment. The packet obtaining apparatus 200 illustrated in FIG. 6 includes a higher-level packet acquisition section 201, a packet loss detection section 202, a null packet detection section 203, a null packet accumulation section 204, a quality influence information extraction section 205, and a quality influence information transmit section 206.

The higher-level packet acquisition section 201 captures the higher-level packets from a multiplexed data stream output from the terminal apparatus 20 to the STB 30. That is, the higher-level packet acquisition section 201 acquires the higher-level packets each containing a predetermined number of video packets, audio packets, and null packets.

The packet loss detection section 202 refers to the respective header portions of the higher-level packets sequentially acquired by the higher-level packet acquisition section 201, and determines whether or not the sequence numbers stored in the header portions are consecutive, to thereby determine the occurrence or non-occurrence of the packet loss. That is, if the sequence numbers of two higher-level packets consecutively acquired by the higher-level packet acquisition section 201 are not consecutive, the packet loss detection section 202 determines that a higher-level packet transmitted between these higher-level packets has been lost. The loss of a higher-level packet indicates the loss of the packets (video packets, audio packets, and null packets) stored in the data portion of the higher-level packet. The lost packets are not received by the STB 30 and the television 40. Therefore, the quality of the video and audio reproduced by the television 40 is deteriorated.

The null packet detection section 203 detects the null packets from the data portion of the higher-level packet acquired by the higher-level packet acquisition section 201. For example, the null packet detection section 203 refers to the packet ID stored in the header portion of each packet, and determines the packet type of the packet. In this case, in each of the video packets and the audio packets, the data portion is encrypted but the header portion is not encrypted. Therefore, the null packet detection section 203 can determine the packet type on the basis of the packet ID of each of the packets stored in the data portion of the higher-level packet. Then, the null packet detection section 203 outputs the null packets contained in the data portion of the higher-level packet to the null packet accumulation section 204.

Further, if the occurrence of a packet loss is detected by the packet loss detection section 202, and if the null packet detection section 203 detects the first null packet after the detection of the packet loss, the null packet detection section 203 outputs to the quality influence information extraction section 205 the information that the first null packet after the detection of the packet loss has been detected. If a null packet is contained in the higher-level packet which has a sequence number not consecutive to the sequence number of the immediately preceding higher-level packet, and which serves as a basis for the detection of the packet loss, the null packet detection section 203 detects the null packet. Meanwhile, if a null packet is not contained in the higher-level packet serving as a basis for the detection of the packet loss, the null packet detection section 203 detects a null packet from the subsequent higher-level packet acquired by the higher-level packet acquisition section 201. That is, the null packet detection section 203 detects the null packet first transmitted after the transmission of the lost higher-level packet. Then, upon detection of the null packet, the null packet detection section 203 notifies the quality influence information extraction section 205 of the information that the null packet has been detected.

The null packet accumulation section 204 accumulates the null packets detected by the null packet detection section 203. Each of the null packets accumulated in the null packet accumulation section 204 stores the quality influence information of the video packet transmitted immediately before the null packet and the video packet transmitted immediately after the null packet. The null packet accumulation section 204 may be configured to sequentially discard the accumulated null packets from the oldest null packet when the number of the accumulated null packets reaches a predetermined number.

When notified by the null packet detection section 203 of the information that the first null packet after the occurrence of the packet loss has been detected, the quality influence information extraction section 205 extracts the quality influence information from the two latest null packets accumulated in the null packet accumulation section 204. That is, the quality influence information extraction section 205 extracts the quality influence information from two null packets respectively transmitted before and after the higher-level packet lost by the packet loss. The data portion is encrypted in the video packets and the audio packets, but is not encrypted in the null packets. Therefore, the quality influence information extraction section 205 can extract the quality influence information from the respective data portions of the two null packets respectively transmitted before and after the lost higher-level packet.

The data portion of each of these null packets stores the quality influence information of the video packet transmitted immediately before the null packet and the video packet transmitted immediately after the null packet. It is therefore assumed that the quality influence information extraction section 205 has extracted the quality influence information relating to the first and last video packets of a section sandwiched by two null packets transmitted at a timing of sandwiching at least the lost higher-level packet. That is, it is assumed that the deterioration of the reproduction quality attributed to the packet loss occurs in the video in the range indicated by the quality influence information extracted by the quality influence information extraction section 205.

The quality influence information transmit section 206 transmits the quality influence information extracted by the quality influence information extraction section 205 to the quality evaluation apparatus 10 via the terminal apparatus 20 and the network N. Thereby, the quality evaluation apparatus 10 receives the quality influence information of the two null packets, and thus can evaluate the degree of deterioration of the video reproduction quality attributed to the packet loss. That is, the quality evaluation apparatus 10 receives the quality influence information including the frame number, the reproduction importance, the position information, the motion information, and so forth corresponding to the section including the lost packet. Therefore, the quality evaluation apparatus 10 can estimate the degree of deterioration of the video reproduction quality due to the packet loss. While separate elements of the packet obtaining apparatus is illustrated in FIG. 6, the present invention is not limited to any particular number of elements.

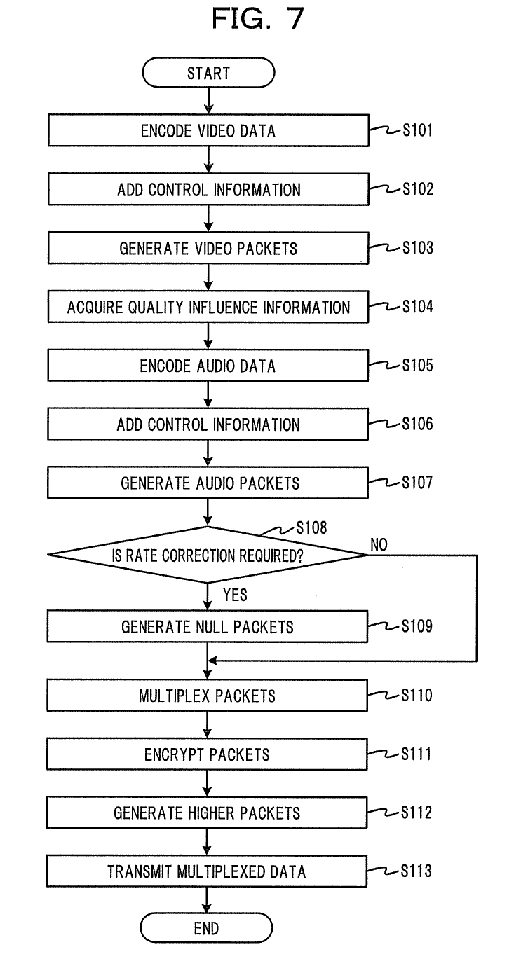

Subsequently, an operation example of the video audio transmit apparatus 100 according to an embodiment will be described with reference to the flowchart illustrated in FIG. 7. In the following, description will be made with reference to specific packet formats and multiplexing methods conforming to MPEG2-TS (Transport Stream) of the MPEG (Moving Picture Experts Group) 2 system, for example.

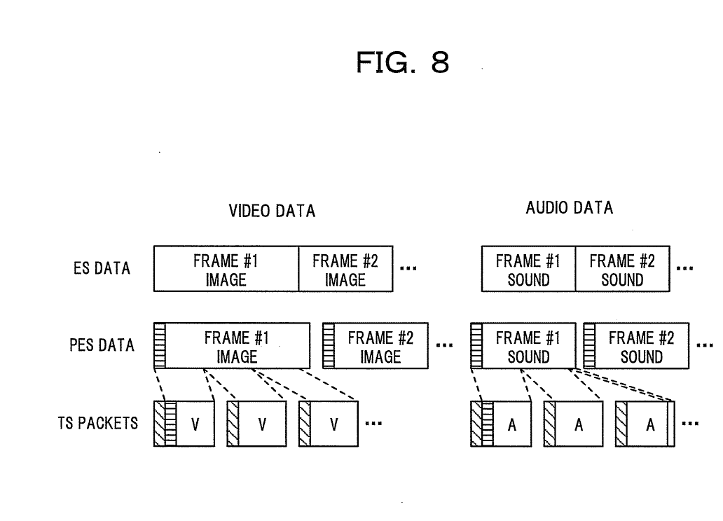

When the video data and audio data to be transmitted are input to the video audio transmit apparatus 100, the video data is input to the video encoding section 101, and the image is encoded on a frame-by-frame basis (at S101). As illustrated in FIG. 8, for example, the respective images of frames #1 and #2 in the video data are encoded on a frame-by-frame basis with an optimal quantization operation. Thereby, ES (Elementary Stream) data is obtained. Herein, a method conforming to MPEG2 may be employed as the encoding method. Another method conforming to, for example, MPEG4 or H.264 may also be employed. Even if the video data is encoded in accordance with MPEG4 or H.264, MPEG2-TS can be employed to multiplex the packets.

After the encoding of the video data, the control information addition section 102 adds control information such as the time stamp to the encoded data of each frame subjected to the encoding process (at S102). As illustrated in FIG. 8, for example, the respective images of the frames #1 and #2 in the ES data are added with the control information, which is hatched with horizontal lines in the drawing. Thereby, PES (Packetized Elementary Stream) data is obtained.

The encoded data added with the control information is input to the packetization section 103, and video packets are generated by the packetization section 103 (at S103). As illustrated in FIG. 8, for example, the PES data of the video is divided into segments each having a fixed length and added with a header portion hatched with diagonal lines in the drawing. Thereby, TS (Transport Stream) packets of the video are generated. The header portion added by the packetization section 103 stores the packet ID indicating that the corresponding TS packet is the video packet containing video data. In FIG. 8, the video packets and the audio packets are represented as “V” and “A,” respectively.

After the generation of the video packets by the packetization section 103, the quality influence information acquisition section 104 acquires the quality influence information from the video packets (at S104). Thereafter, the video packets are output from the packetization section 103 to the rate adjustment section 109. For example, the quality influence information acquisition section 104 acquires the quality influence parameters of the encoded data contained in the video packets, such as the frame number, the reproduction importance, the position information, the motion information, and the quantization operation. These quality influence parameters are factors substantially affecting the video reproduction quality, and thus serve as important information for estimating a degree of deterioration of the video reproduction quality in the event of the loss of a video packet, for example. The acquired quality influence information of the video packets is held by the quality influence information acquisition section 104.

Meanwhile, the audio data input to the video audio transmit apparatus 100 is input to the audio encoding section 106, and the sound is encoded on a frame-by-frame basis (at S105). As illustrated in FIG. 8, for example, the respective sounds of frames #1 and #2 in the audio data are encoded. Thereby, ES data is obtained. Herein, AAC (Advanced Audio Coding) or HE (High Efficiency)-AAC, for example, can be employed as the encoding method.

After the encoding of the audio data, the control information addition section 107 adds control information such as the time stamp to the encoded data of each frame subjected to the encoding process (at S106). As illustrated in FIG. 8, for example, the respective sounds of the frames #1 and #2 in the ES data are added with the control information, which is hatched with horizontal lines in the drawing. Thereby, PES data is obtained.

The encoded data added with the control information is input to the packetization section 108, and audio packets are generated by the packetization section 108 (at S107). As illustrated in FIG. 8, for example, the PES data of the audio is divided into segments each having a fixed length and added with a header portion hatched with diagonal lines in the drawing. Thereby, TS packets of the audio are generated. The header portion added by the packetization section 108 stores the packet ID indicating that the TS packet is the audio packet containing audio data. In the generation of the TS packets, padding or the like is performed as appropriate such that the head of each of the frames of the PES data is located immediately after the header portion of the corresponding TS packet.

After the generation of the audio packets by the packetization section 108, the audio packets are output from the packetization section 108 to the rate adjustment section 109. Then, the rate adjustment section 109 determines the packet arrangement in the time-division multiplexing on the video packets and the audio packets, and determines whether or not a null packet needs to be inserted to correct the transmission rate (at S108). If the number of the video or audio packets is insufficient to achieve a predetermined transmission rate, the rate adjustment section 109 determines that a null packet is required.

If it is determined that a null packet is required to correct the transmission rate (YES in S108), the rate adjustment section 109 determines the insertion position of the null packet, and specifies the video packet located immediately before the null packet and the video packet located immediately after the null packet. Then, the null packet generation section 105 is notified of the information that the null packet is to be inserted and the information identifying the specified video packets. In accordance with this notification, the null packet generation section 105 acquires from the quality influence information acquisition section 104 the quality influence information of the video packet located immediately before the null packet and the video packet located immediately after the null packet, and generates the null packet storing the acquired quality influence information in the data portion thereof (at S109). The header portion of the null packet stores the packet ID indicating that the packet type is the null packet.

The null packets generated by the null packet generation section 105 are output to the rate adjustment section 109, and are output from the rate adjustment section 109 to the multiplexing section 110 together with the video packets and the audio packets. Further, if the null packet for correcting the transmission rate is determined to be unnecessary (NO in S108), the video packets and the audio packets are output from the rate adjustment section 109 to the multiplexing section 110 without the generation of the null packet.

Then, the multiplexing section 110 performs the time-division multiplexing on the video packets, the audio packets, and the null packets in accordance with the packet arrangement determined by the rate adjustment section 109 (at S110). Thereby, the video packets, the audio packets, and the null packets are multiplexed to achieve a predetermined transmission rate. Each of the null packets stores the quality influence information of the video packet located immediately before the null packet and the video packet located immediately after the null packet. Then, the packet train obtained by the time-division multiplexing is output to the encryption section 111, and the respective data portions of the video packets and the audio packets included in the packet train are encrypted (at S111).

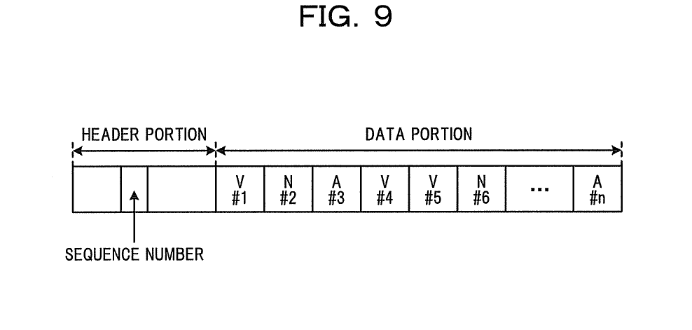

The packet train including the video packets and the audio packets each having the encrypted data portion is output to the transmit section 112, and the transmit section 112 processes the higher layer for transmission. For example, the transmit section 112 divides the packets of the packet train into groups each including a predetermined number of packets and added with a header portion storing the sequence number, to thereby generate higher-level packets (at S112). As illustrated in FIG. 9, for example, the n (n represents an integer equal to or more than one) number of video packets, audio packets, and null packets from a packet V#1 to a packet A#n are added with a header portion to generate a higher-level packet. In FIG. 9, “V,” “A,” and “N” represent the video packet, the audio packet, and the null packet, respectively. Further, #1 to #n represent the identification numbers of the packets in the data portion of the higher-level packet.

As illustrated in FIG. 9, the header portion of the higher-level packet stores the sequence number. The sequence number represents the serial number of the higher-level packet. If the higher-level packets are consecutively transmitted, the sequence numbers stored in the respective header portions are also consecutive. Therefore, an apparatus receiving the higher-level packets, such as the packet obtaining apparatus 200, for example, checks the continuity of the sequence numbers of the higher-level packets, and thereby can determine whether or not the packet loss of a higher-level packet has occurred in the network N.

In the present embodiment, the packet loss is detected in units of higher-level packets on the basis of the sequence number of the higher-level packet. The header portion of each of the video packets and the audio packets stores the continuity counter for each packet type. Therefore, the packet loss may also be detected in units of TS packets on the basis of the continuity counter. However, numbers 1 to 15, for example, are repeatedly used as the continuity counter. Therefore, if sixteen video packets (or audio packets) are lost at the same time, the continuity counter does not indicate discontinuity. As a result, accurate detection of the packet loss is not achieved solely by the continuity counter. Therefore, the sequence number of the higher-level packet may be supplementarily referred to detect the packet loss. Further, the packet loss may also be detected without the use of the sequence number of the higher-level packet or the continuity counter of the packet.

The higher-level packets generated by the transmit section 112 are transmitted as multiplexed data including multiplexed video and audio (at S113). The multiplexed data is received by the STB 30 and the television 40 in each dwelling unit via the network N and the terminal apparatus 20. Then, the video and audio are reproduced by the individual television 40.

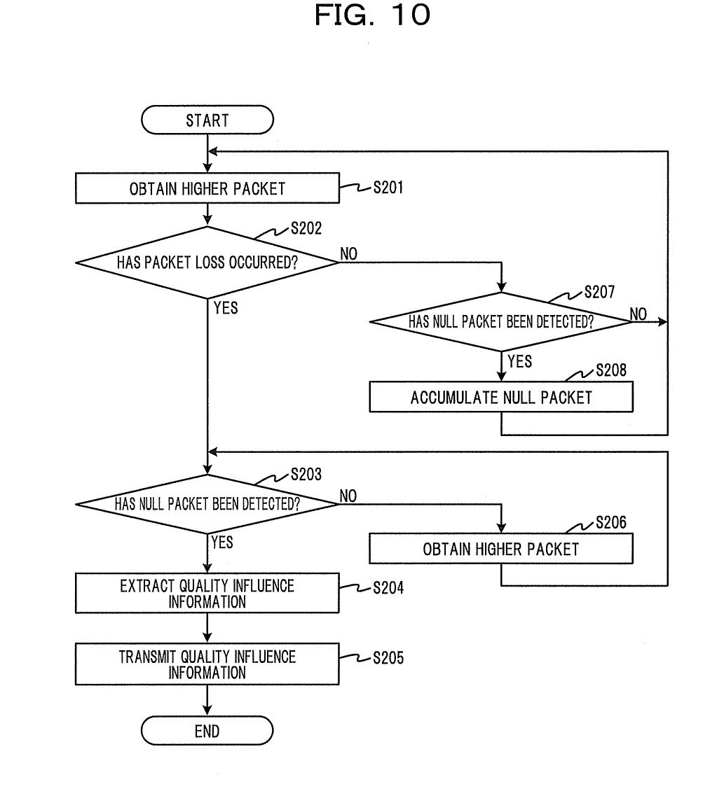

Subsequently, an operation example of the packet obtaining apparatus 200 according to an embodiment will be described with reference to the flowchart illustrated in FIG. 10.

In an embodiment, the packet obtaining apparatus 200 is provided between the terminal apparatus 20 and the STB 30 for each dwelling unit (recipient location). Therefore, the packets are obtained by the packet obtaining apparatus 200 from a multiplexed data stream output from the terminal apparatus 20 to the STB 30 for each dwelling unit. For example, the higher-level packet acquisition section 201 obtains from the multiplexed data stream a higher-level packet containing the video packets, the audio packets, and the null packets (at S201).

After the higher-level packet is obtained by the higher-level packet acquisition section 201, the packet loss detection section 202 determines whether or not the packet loss of a higher-level packet has occurred in the network N (at S202). For example, the packet loss detection section 202 determines whether or not the sequence number stored in the header portion of the present higher-level packet is consecutive to the sequence number of the last higher-level packet obtained by the higher-level packet acquisition section 201. If it is determined that the sequence numbers are consecutive, the packet loss detection section 202 determines that the packet loss in the network N has not occurred (NO in S202). Meanwhile, if the sequence numbers are not consecutive, the packet loss detection section 202 determines that the packet loss in the network N has occurred (YES in S202).

If the packet loss detection section 202 determines that the packet loss has not occurred (NO in S202), the null packet detection section 203 determines whether or not the higher-level packet contains a null packet (at S207). For example, the null packet detection section 203 refers to the packet ID of each of the packets contained in the data portion of the higher-level packet, and determines whether or not there is a packet having a packet ID indicating that the packet is the null packet. Then, if a null packet is not detected from the higher-level packet (NO in S207), the higher-level packet acquisition section 201 continues to obtain other higher-level packets, and the above-described processes are repeated. Further, if a null packet is detected from the higher-level packet (YES in S207), the detected null packet is accumulated in the null packet accumulation section 204 (at S208). Thereafter, the higher-level packet obtaining process by the higher-level packet acquisition section 201 and the subsequent processes are repeated, similarly as in the case in which a null packet is not detected.

Meanwhile, if the packet loss detection section 202 determines that the packet loss has occurred (YES in S202), the null packet detection section 203 determines whether or not the higher-level packet contains a null packet (at S203). Also in this case, the presence or absence of a null packet is determined on the basis of the packet ID of each of the packets, similarly as in the above-described case in which the packet loss has not occurred. Then, if a null packet is not detected from the higher-level packet (NO in S203), the higher-level packet acquisition section 201 obtains a new higher-level packet (at S206). Then, the presence or absence of a null packet is again determined (at S203). In other words, the detection of a null packet by the null packet detection section 203 is repeated until the null packet first transmitted after the higher-level packet lost by the packet loss is detected.

Then, if the null packet first transmitted after the higher-level packet lost by the packet loss is detected (YES in S203), the detected null packet is accumulated in the null packet accumulation section 204, similarly to the other null packets. Then, the quality influence information extraction section 205 extracts the quality influence information, for example, from the two latest null packets accumulated in the null packet accumulation section 204 (at S204). That is, the quality influence information extraction section 205 extracts the quality influence information stored in the null packets sandwiching the higher-level packet lost by the packet loss and respectively transmitted before and after the higher-level packet.

The quality influence information extracted by the quality influence information extraction section 205 includes the quality influence parameters, such as the frame number, the reproduction importance, the position information, the motion information, and the quantization operation, which relate to the first and last video packets of a section sandwiched by the two null packets respectively transmitted before and after the lost higher-level packet. Therefore, the deterioration of the video reproduction quality due to the loss of the higher-level packet can be estimated on the basis of the quality influence information extracted by the quality influence information extraction section 205. For example, the frame number of the frame affected by the packet loss can be estimated on the basis of the frame number included in the quality influence information. Further, the degree of the influence of the packet loss on the decoding can be estimated on the basis of the reproduction importance included in the quality influence information. Further, for example, whether or not the quality deterioration due to the packet loss is conspicuous in the video reproduction can be estimated on the basis of the position information and the motion information included in the quality influence information.

As described above, the quality influence information extracted by the quality influence information extraction section 205 includes sufficient quality influence parameters for estimating the quality of the video reproduced by the television 40. Then, the quality influence information extracted by the quality influence information extraction section 205 is output to the quality influence information transmit section 206, and is transmitted by the quality influence information transmit section 206 to the quality evaluation apparatus 10 via the terminal apparatus 20 and the network N (at S205). Thereby, the quality evaluation apparatus 10 can estimate the degree of deterioration of the video reproduction quality according to the packet loss.

In the present embodiment, the video audio transmit apparatus 100 multiplexes packets by inserting therein null packets to correct the transmission rate. Thus, the quality influence information of each of all video packets is not necessarily stored in one of the null packets. Therefore, which one of the video packets has the quality influence information thereof stored in a null packet relies on the packet arrangement in the multiplexing of the packets.

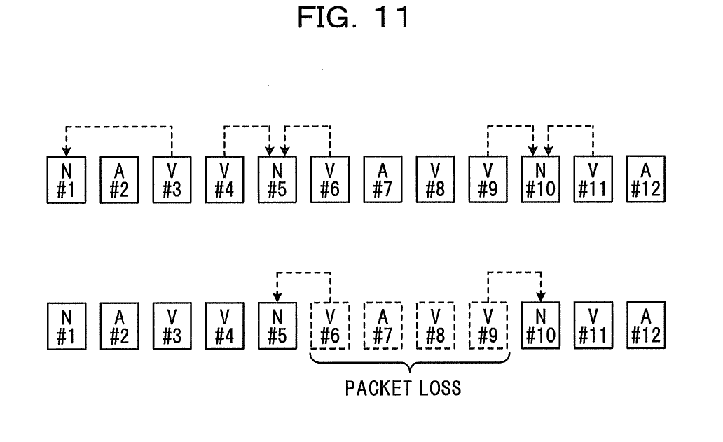

FIG. 11 illustrates an example of the packet arrangement according to the present embodiment. In FIG. 11, the video packets, the audio packets, and the null packets are represented as “V,” “A,” and “N,” respectively. Further, #1 to #12 represent the identification numbers of the packets. In the following, the null packet with the identification number #1, for example, will be referred to as the “null packet N#1.” As illustrated in FIG. 11, null packets N#1, N#5, and N#10 are not regularly arranged, but are arranged to correct the transmission rate of the packets to a constant value. In this arrangement, the null packet N#1 stores the quality influence information of a video packet V#3, the null packet N#5 stores the quality influence information of video packets V#4 and V#6, and the null packet N#10 stores the quality influence information of video packets V#9 and V#11. Meanwhile, the quality influence information of a video packet V#8 is not stored in any of the null packets.

Practically, however, the null packet is relatively frequently inserted in many cases, and thus the quality influence information of each of most video packets is stored in one of the null packets. For example, if the encoding method and the transmission rate of the video data are MPEG2 and 13 Mbps, respectively, and if the encoding method and the transmission rate of the audio data are AAC and 192 kbps, respectively, the total number of packets transmitted from the video audio transmit apparatus 100 during 0.5 seconds is 9969, for example. The total of 9969 packets include 4483 video packets, 50 audio packets, and 5257 null packets, for example. The remaining packets include packets for data broadcasting, for example.

As described above, the null packets account for more than half the total packet number. Therefore, with each of the null packets storing the quality influence information of the video packet located immediately before the null packet and the video packet located immediately after the null packet, the quality influence information of each of most video packets is stored in one of the null packets. If a video packet is lost by the packet loss, therefore, it is highly possible that the quality influence information of the lost video packet is stored in the null packet preceding the video packet and the null packet following the video packet. Accordingly, with the quality influence information acquired from the null packets, it is possible to acquire the information relating to the lost packet, and to estimate the degree of deterioration of the video reproduction quality due to the packet loss.

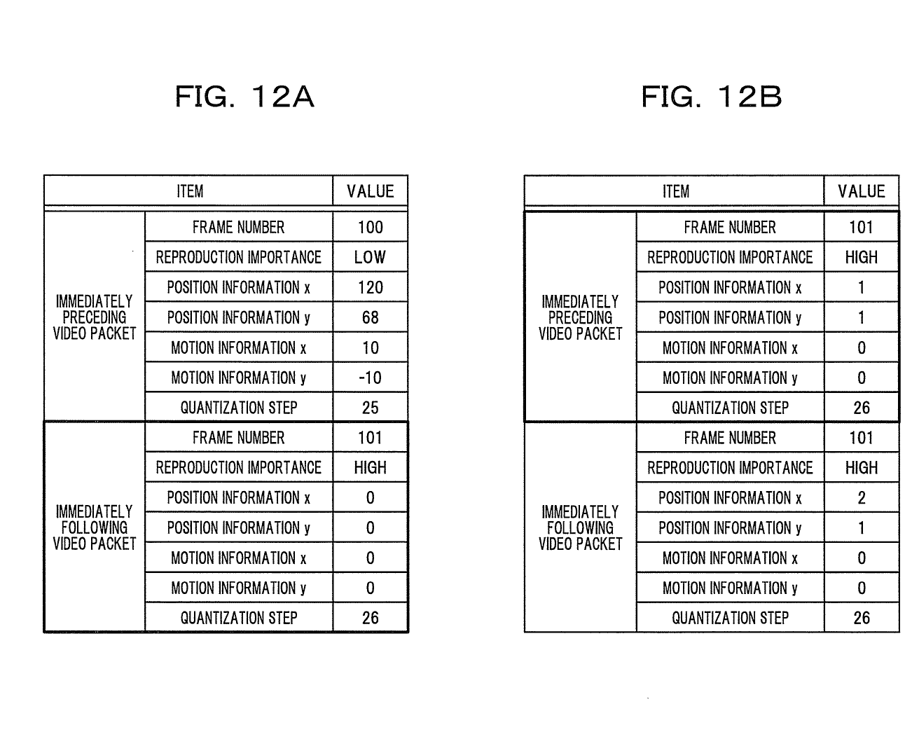

In the example illustrated in FIG. 11, if the packets V#6 to V#9 are lost by the packet loss, the quality influence information stored in the null packets N#5 and N#10 sandwiching the lost packets and respectively transmitted before and after the lost packets is extracted by the quality influence information extraction section 205 of the packet obtaining apparatus 200. It is assumed herein that the null packets N#5 and N#10 store, for example, the quality influence information illustrated in FIG. 12A and the quality influence information illustrated in FIG. 12B, respectively. The video packet immediately preceding the null packet N#5 is the video packet V#4, and the video packet immediately following the null packet N#5 is the video packet V#6. Further, the video packet immediately preceding the null packet N#10 is the video packet V#9, and the video packet immediately following the null packet N#10 is the video packet V#11.

Therefore, on the basis of the quality influence information of the immediately following video packet V#6 stored in the null packet N#5 and the quality influence information of the immediately preceding video packet V#9 stored in the null packet N#10, the degree of deterioration of the video reproduction quality due to the packet loss can be estimated. That is, on the basis of the information of the parts enclosed by bold lines in FIGS. 12A and 12B, the deterioration of the reproduction quality due to the loss of the video packets can be estimated.

For example, both of the parts enclosed by the bold lines in FIGS. 12A and 12B have a frame number 101. It is therefore understood that the number of the frame having the video data lost by the packet loss is 101. Further, due to high reproduction importance, it is presumed that the image of this frame is the I-picture and affects the decoding of a relatively large number of frames. Further, it is found that the lost video packets contain the data of a macroblock at a coordinate position in a range from the coordinates (0, 0) to the coordinates (1, 1). It is therefore presumed that a macroblock relatively near the periphery of the image is affected by the packet loss.

If the quality influence information sets to be referred to have different frame numbers (e.g., frame numbers 101 and 103), it is understood that the video data of one of the frames between these frame numbers (a frame assigned with one of the numbers 101 to 103) has been lost by the packet loss. As described above, the quality influence information stored in a null packet includes sufficient information for estimating the influence of the loss of the corresponding video packet on the reproduction quality. Accordingly, with the quality influence information transmitted from the quality influence information transmit section 206 to the quality evaluation apparatus 10, the quality evaluation apparatus 10 can estimate the video reproduction quality.

As described above, in the present embodiment, multiplexed data including null packets and video packets is transmitted, with each of the null packets storing the quality influence information of the video packet located immediately before the null packet and the video packet located immediately after the null packet. Further, the multiplexed data is obtained in the vicinity of the position at which the multiplexed data is received and reproduced, and the quality influence information is acquired from the null packet preceding the packet lost by the packet loss and the null packet following the lost packet. Accordingly, it is possible to acquire from the null packets the information relating to a portion including the lost packet, and to estimate the degree of deterioration of the reproduction quality due to the packet loss. In other words, it is possible to acquire sufficient information for estimating the quality of the video reproduced by a user terminal.

In the above-described embodiment, the quality influence information of the video packets is transmitted as stored in the null packets. It is also possible to transmit the quality influence information of the audio packets as stored in the null packets. In an embodiment, therefore, description will be made of a case in which the quality influence information of the audio packets is stored in the null packets. Also in this case, the network configuration is similar to the network configuration according to an embodiment, and thus description thereof will be omitted. In the following, description will be made mainly of the differences in configuration and operation between the video audio transmit apparatus 100 according to the present embodiment and the video audio transmit apparatus 100 according to the first embodiment.

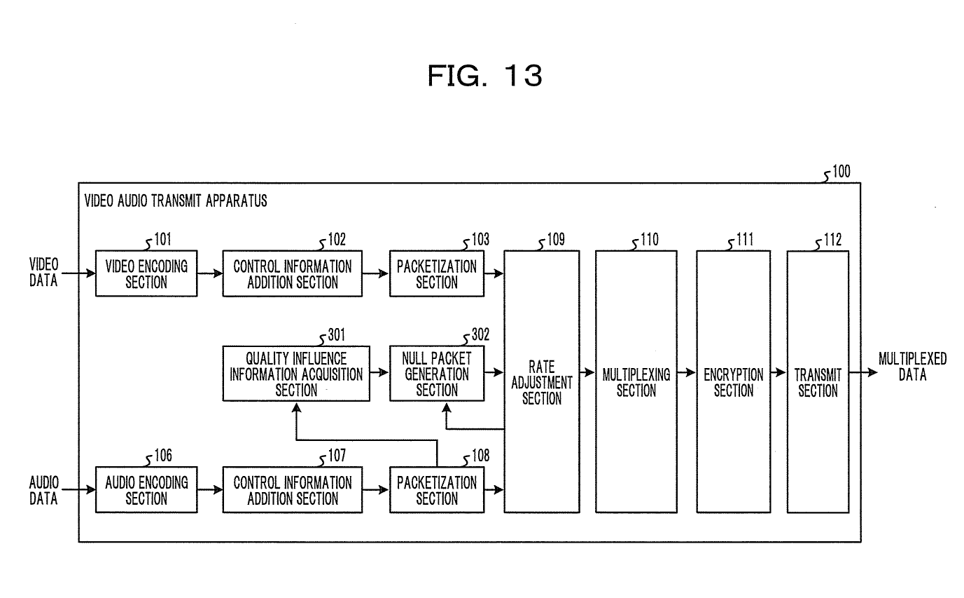

FIG. 13 is a block diagram illustrating a configuration of essential components of the video audio transmit apparatus 100 according to the present embodiment. In FIG. 13, the same components as the components of FIG. 2 are designated by the same reference numerals, and description thereof will be omitted. The video audio transmit apparatus 100 illustrated in FIG. 13 includes a quality influence information acquisition section 301 and a null packet generation section 302 in place of the quality influence information acquisition section 104 and the null packet generation section 105 of the video audio transmit apparatus 100 illustrated in FIG. 2.

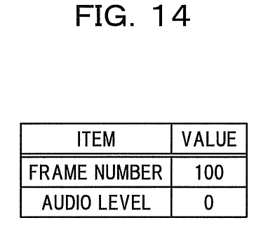

After the generation of the audio packets by the packetization section 108, the quality influence information acquisition section 301 acquires the quality influence information representing the influence of each of the generated audio packets on the reproduction quality of the entire audio. For example, the quality influence information acquisition section 301 acquires the quality influence parameters illustrated in FIG. 14. That is, the quality influence information acquisition section 301 acquires the frame number and the audio level of the encoded data contained in each audio packet as the quality influence parameters of the audio packet. As described above, the quality influence parameters according to the present embodiment affect the reproduction quality of the entire audio.

The frame number represents the serial number assigned to each frame, and indicates which one of the frames forming the entire audio has the audio, the reproduction quality of which is affected by the audio packet. The audio level represents the audio level of the encoded data contained in the audio packet. For example, if the audio is silent, the audio level is represented as 0. If the audio is sonant, a numeric value according to the corresponding audio level represents the information of the audio level. In the event of a packet loss, therefore, if the lost packet is an audio packet at a relatively high audio level, the deterioration of the audio reproduction quality is relatively substantial. Meanwhile, if the lost packet is a silent audio packet, the deterioration of the audio reproduction quality is relatively minor. The quality influence information is not limited only to the quality influence parameters illustrated in FIG. 14, and may include other quality influence parameters affecting the reproduction quality of the entire audio.

Returning to FIG. 13, when notified by the rate adjustment section 109 that a null packet is to be inserted to correct the transmission rate, the null packet generation section 302 acquires from the quality influence information acquisition section 301 the quality influence information of the audio packet located immediately before the null packet and the audio packet located immediately after the null packet. Then, the null packet generation section 302 adds header information to the acquired quality influence information to form the null packet, and outputs the formed null packet to the rate adjustment section 109. That is, the null packet generation section 302 generates a null packet, the data portion of which stores the quality influence information of two audio packets respectively located immediately before and immediately after the null packet, and the header portion of which stores the packet ID and so forth. In this process, the null packet generation section 302 does not store data such as video or audio in the data portion of the null packet.

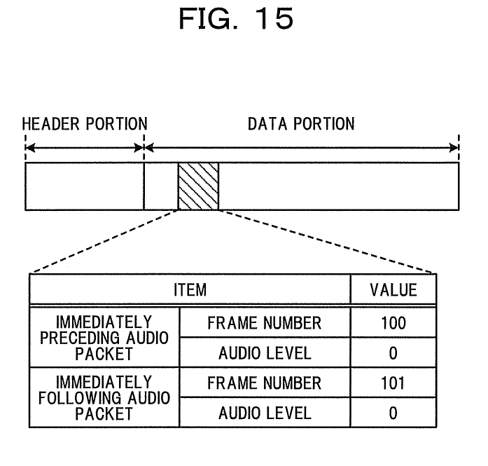

For example, as illustrated in FIG. 15, the null packet generation section 302 stores, in the data portion, the quality influence information of both the audio packet located immediately before the null packet and the audio packet located immediately after the null packet. In this process, the null packet generation section 302 may generate the null packet such that a value “1,” for example, is stored in the respective bits of a region of the data portion other than the region storing the quality influence information. Further, the null packet generation section 302 stores, in the header portion, the packet ID indicating that the packet is the null packet.

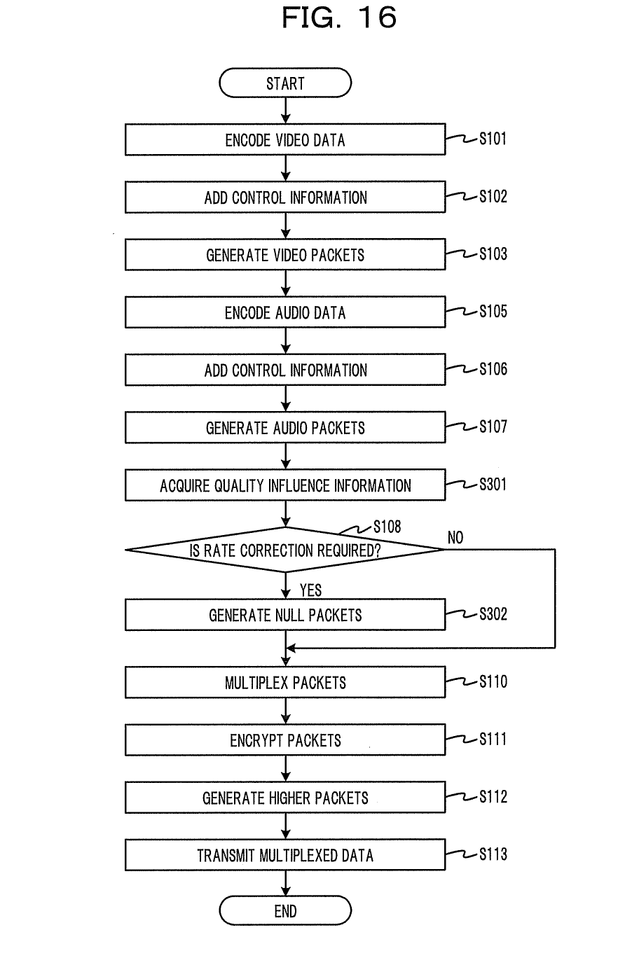

Subsequently, description will be made of an operation example of the video audio transmit apparatus 100 configured as described above, with reference to the flowchart illustrated in FIG. 16. In FIG. 16, the same operations as the operations of FIG. 7 are designated by the same reference numerals, and detailed description thereof will be omitted.

When the video data and audio data to be transmitted are input to the video audio transmit apparatus 100, the video data is input to the video encoding section 101, and the image is encoded on a frame-by-frame basis (at S101). After the encoding of the video data, the control information addition section 102 adds control information such as the time stamp to the encoded data of each frame subjected to the encoding process (at S102). The encoded data added with the control information is input to the packetization section 103, and video packets are generated by the packetization section 103 (at S103). The generated video packets are output from the packetization section 103 to the rate adjustment section 109.

Meanwhile, the audio data input to the video audio transmit apparatus 100 is input to the audio encoding section 106, and the sound is encoded on a frame-by-frame basis (at S105). After the encoding of the audio data, the control information addition section 107 adds control information such as the time stamp to the encoded data of each frame subjected to the encoding process (at S106). The encoded data added with the control information is input to the packetization section 108, and audio packets are generated by the packetization section 108 (at S107).

After the generation of the audio packets by the packetization section 108, the quality influence information acquisition section 301 acquires the quality influence information from the audio packets (at S301). Thereafter, the audio packets are output from the packetization section 108 to the rate adjustment section 109. For example, the quality influence information acquisition section 301 acquires the quality influence parameters of the encoded data contained in the audio packets, such as the frame number and the audio level. These quality influence parameters are factors substantially affecting the audio reproduction quality, and thus serve as important information for estimating the degree of deterioration of the audio reproduction quality in the event of the loss of an audio packet, for example. The acquired quality influence information of the audio packets is held by the quality influence information acquisition section 301.

Then, the rate adjustment section 109 determines the packet arrangement in the time-division multiplexing on the video packets and the audio packets, and determines whether or not a null packet needs to be inserted to correct the transmission rate (at S108). If it is determined that a null packet is required to correct the transmission rate (YES in S108), the rate adjustment section 109 determines the insertion position of the null packet, and specifies the audio packet located immediately before the null packet and the audio packet located immediately after the null packet. Then, the null packet generation section 302 is notified of the information that the null packet is to be inserted and the information identifying the specified audio packets, and generates the null packet (at S302). The null packet generated by the null packet generation section 302 stores, in the data portion thereof, the quality influence information of the audio packet located immediately before the null packet and the audio packet located immediately after the null packet, and stores, in the header portion thereof, the packet ID indicating that the packet type is the null packet.

The null packets generated by the null packet generation section 302 are output to the rate adjustment section 109, and are output from the rate adjustment section 109 to the multiplexing section 110 together with the video packets and the audio packets. Further, if the null packet for correcting the transmission rate is determined to be unnecessary (NO in S108), the video packets and the audio packets are output from the rate adjustment section 109 to the multiplexing section 110 without the generation of the null packet.

Then, the multiplexing section 110 performs the time-division multiplexing on the video packets, the audio packets, and the null packets in accordance with the packet arrangement determined by the rate adjustment section 109 (at S110). After a packet train is obtained by the time-division multiplexing, the encryption section 111 encrypts the respective data portions of the video packets and the audio packets included in the packet train (at S111).

The packet train including the video packets and the audio packets each having the encrypted data portion is output to the transmit section 112, and the transmit section 112 generates higher-level packets from the packet train (at S112). The higher-level packets generated by the transmit section 112 are transmitted as multiplexed data including multiplexed video and audio (at S113). The multiplexed data is received by the STB 30 and the television 40 in each dwelling unit via the network N and the terminal apparatus 20. Then, the video and audio are reproduced by the individual television 40.

In the present embodiment, the quality influence information of the audio packets is stored in the null packets. In the event of a packet loss, therefore, the packet obtaining apparatus 200 acquires the quality influence information of the audio packets from the null packets. Except for this feature, the configuration and operation of the packet obtaining apparatus 200 according to the present embodiment are similar to the configuration (see FIG. 6) and operation (See FIG. 10) of the packet obtaining apparatus 200 according to an embodiment.

In the present embodiment, the video audio transmit apparatus 100 multiplexes packets by inserting therein null packets to correct the transmission rate. Thus, the quality influence information of each of all audio packets is not necessarily stored in one of the null packets. Therefore, which one of the audio packets has the quality influence information thereof stored in a null packet relies on the packet arrangement in the multiplexing of the packets.

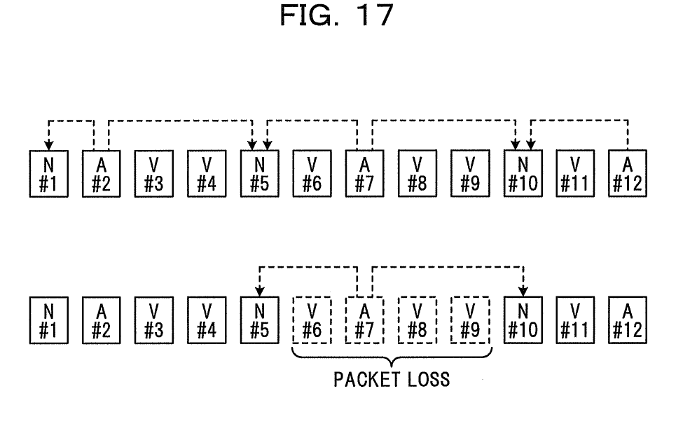

FIG. 17 illustrates another example of the packet arrangement according to the present embodiment. In FIG. 17, the video packets, the audio packets, and the null packets are represented as “V,” “A,” and “N,” respectively. Further, #1 to #12 represent the identification numbers of the packets. As illustrated in FIG. 17, null packets N#1, N#5, and N#10 are not regularly arranged, but are arranged to correct the transmission rate of the packets to a constant value. In this arrangement, the null packet N#1 stores the quality influence information of an audio packet A#2, the null packet N#5 stores the quality influence information of audio packets A#2 and A#7, and the null packet N#10 stores the quality influence information of audio packets A#7 and A#12.

Generally, the transmission rate of the audio data is set to be lower than the transmission rate of the video data in many cases. Therefore, the number of audio packets arranged in multiplexed data is substantially less than the number of video packets arranged in the multiplexed data. Further, in general, the number of null packets is approximately equal to or more than the number of video packets. Thus, the quality influence information of each of most audio packets is stored in one of the null packets. If an audio packet is lost by the packet loss, therefore, it is highly possible that the quality influence information of the lost audio packet is stored in the null packet preceding the audio packet and the null packet following the audio packet. Accordingly, with the quality influence information acquired from the null packets, it is possible to acquire the information relating to the lost packet, and to estimate the degree of deterioration of the audio reproduction quality due to the packet loss.

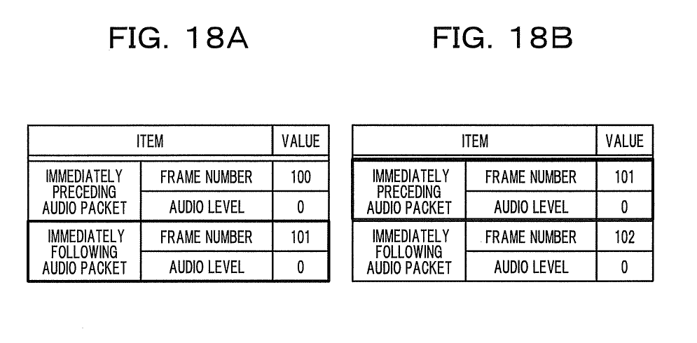

In the example illustrated in FIG. 17, if packets V#6 to V#9 are lost by the packet loss, the quality influence information stored in the null packets N#5 and N#10 sandwiching the lost packets and respectively transmitted before and after the lost packets is extracted by the packet obtaining apparatus 200. It is assumed herein that the null packets N#5 and N#10 store, for example, the quality influence information illustrated in FIG. 18A and the quality influence information illustrated in FIG. 18B, respectively. The audio packet immediately preceding the null packet N#5 is the audio packet A#2, and the audio packet immediately following the null packet N#5 is the audio packet A#7. Further, the audio packet immediately preceding the null packet N#10 is the audio packet A#7, and the audio packet immediately following the null packet N#10 is the audio packet A#12.

Therefore, on the basis of the quality influence information of the immediately following audio packet A#7 stored in the null packet N#5 and the quality influence information of the immediately preceding audio packet A#7 stored in the null packet N#10, the degree of deterioration of the audio reproduction quality due to the packet loss can be estimated. That is, on the basis of the information of the parts enclosed by bold lines in FIGS. 18A and 18B, the deterioration of the reproduction quality due to the loss of the audio packet can be estimated. Herein, only one audio packet A#7 is transmitted between the null packets N#5 and N#10. Therefore, the quality influence information enclosed by the bold line in FIG. 18A and the quality influence information enclosed by the bold line in FIG. 18B relate to the same audio packet A#7.

In FIG. 18, both of the parts enclosed by the bold lines in FIGS. 18A and 18B have a frame number 101. It is therefore understood that the number of the frame having the audio data lost by the packet loss is 101. Further, this frame is silent with an audio level of 0. It is therefore presumed that the frame does not substantially affect the audio reproduction quality. As described above, the quality influence information stored in a null packet includes sufficient information for estimating the influence of the loss of the corresponding audio packet on the reproduction quality. Accordingly, with the quality influence information extracted by the packet obtaining apparatus 200 and transmitted to the quality evaluation apparatus 10, the quality evaluation apparatus 10 can estimate the audio reproduction quality.

As described above, in an embodiment, multiplexed data including null packets and audio packets is transmitted, with each of the null packets storing the quality influence information of the audio packet located immediately before the null packet and the audio packet located immediately after the null packet. Further, the multiplexed data is obtained in the vicinity of the position at which the multiplexed data is received and reproduced, and the quality influence information is acquired from the null packet preceding the packet lost by the packet loss and the null packet following the lost packet. Accordingly, it is possible to acquire from the null packets the information relating to a portion including the lost packet, and to estimate the degree of deterioration of the reproduction quality due to the packet loss. In other words, it is possible to acquire sufficient information for estimating the quality of the audio reproduced by a user terminal.

In the above-described embodiments, the quality influence information of the video packets or the audio packets is transmitted as stored in the null packets. It is also possible to transmit the quality influence information of both the video packets and the audio packets as stored in the null packets. In an embodiment, therefore, description will be made of a case in which the quality influence information of the video packets and the audio packets is stored in the null packets. Also in this case, the network configuration is similar to the network configuration according to an embodiment, and thus description thereof will be omitted. In the following, description will be made mainly of the differences in configuration and operation between the video audio transmit apparatus 100 according to the present embodiment and the video audio transmit apparatus 100 according to an embodiment.

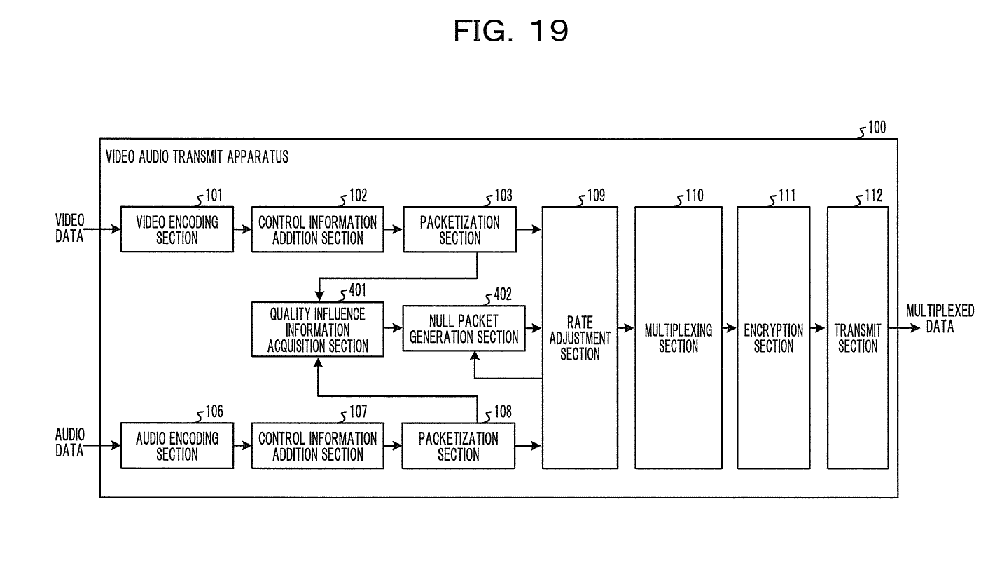

FIG. 19 is a block diagram illustrating a configuration of essential components of the video audio transmit apparatus 100 according to the present embodiment. In FIG. 19, the same components as the components of FIG. 2 are designated by the same reference numerals, and description thereof will be omitted. The video audio transmit apparatus 100 illustrated in FIG. 19 includes a quality influence information acquisition section 401 and a null packet generation section 402 in place of the quality influence information acquisition section 104 and the null packet generation section 105 of the video audio transmit apparatus 100 illustrated in FIG. 2.

After the generation of the video packets and the audio packets by the packetization sections 103 and 108, respectively, the quality influence information acquisition section 401 acquires the quality influence information from the respective packets. For example, the quality influence information acquisition section 401 acquires the quality influence parameters of the video packets described in an embodiment (see FIG. 4) and the quality influence parameters of the audio packets described in an embodiment (see FIG. 14).

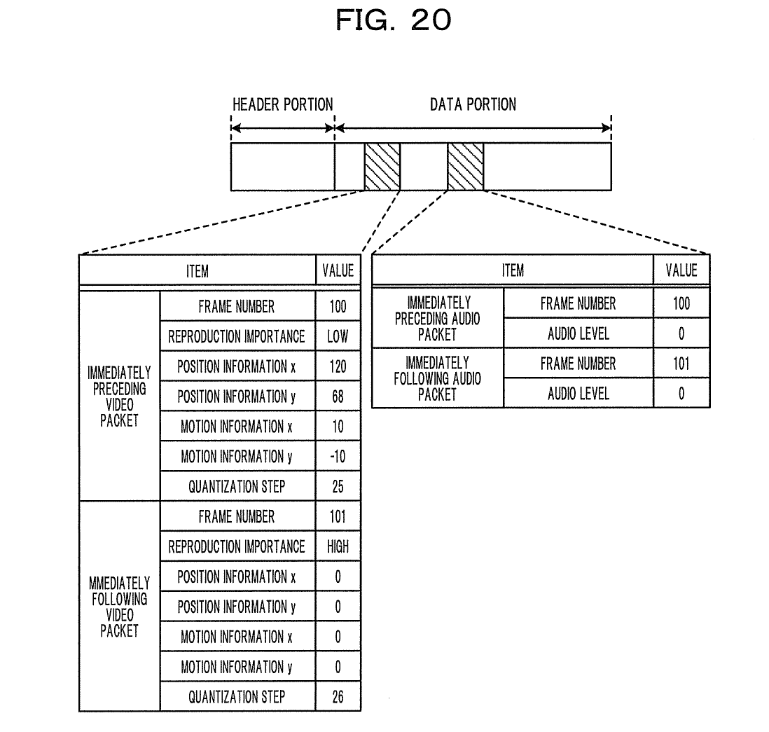

When notified by the rate adjustment section 109 that a null packet is to be inserted to correct the transmission rate, the null packet generation section 402 acquires from the quality influence information acquisition section 401 the quality influence information of the video packet and the audio packet located immediately before the null packet and the video packet and the audio packet located immediately after the null packet. Then, the null packet generation section 402 generates the null packet by storing the acquired quality influence information in the data portion thereof, and outputs the generated null packet to the rate adjustment section 109. Specifically, as illustrated in FIG. 20, for example, the null packet generation section 402 stores, in the data portion, the quality influence information of the video packet and the audio packet located immediately before the null packet and the video packet and the audio packet located immediately after the null packet. In this process, the null packet generation section 402 may generate the null packet such that a bit string containing only “1” bits, for example, is stored in a region of the data portion other than the region storing the quality influence information. Further, the null packet generation section 402 stores, in the header portion, the packet ID indicating that the packet is the null packet.

In the present embodiment, the quality influence information of the video packets and the audio packets is stored in the null packets. Therefore, the amount of information stored in the data portion of each of the null packets is increased. However, the packets having the quality influence information thereof stored in a null packet are the video packet and the audio packet located immediately before the null packet and the video packet and the audio packet located immediately after the null packet, i.e., only four packets at most. Therefore, even if the quality influence information of the four packets is stored in the data portion of the null packet, the data portion does not suffer from a shortage in size for storing other data.

Further, although the quality influence information of each of all video packets and audio packets is not necessarily stored in a null packet, multiplexed data includes a relatively large number of null packets. Thus, the quality influence information of each of most video packets and audio packets is stored in one of the null packets. If a video or audio packet is lost by the packet loss, therefore, it is highly possible that the quality influence information of the lost video or audio packet is stored in the null packet preceding the lost packet and the null packet following the lost packet. Accordingly, with the quality influence information acquired from null packets by the packet obtaining apparatus 200, it is possible to acquire the information relating to the lost packet, and to estimate the degree of deterioration of the video and audio reproduction quality due to the packet loss.

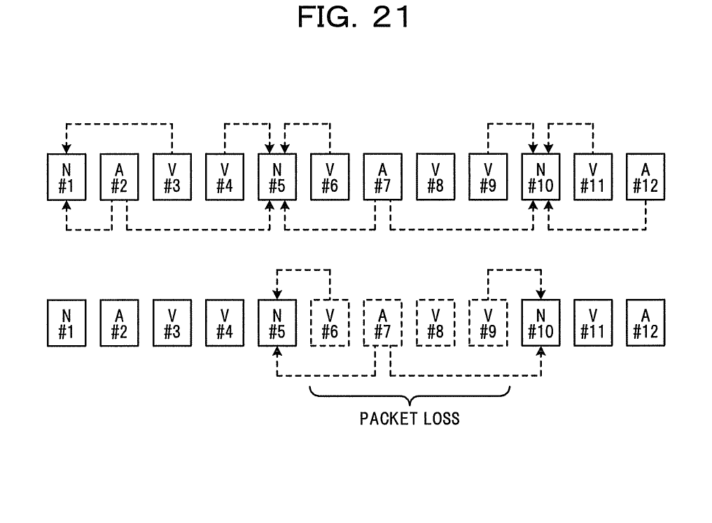

FIG. 21 illustrates another example of the packet arrangement according to the present embodiment. In FIG. 21, the video packets, the audio packets, and the null packets are represented as “V,” “A,” and “N,” respectively. Further, #1 to #12 represent the identification numbers of the packets. As illustrated in FIG. 21, null packets N#1, N#5, and N#10 are not regularly arranged, but are arranged to correct the transmission rate of the packets to a constant value. In this arrangement, the null packet N#1 stores the quality influence information of a video packet V#3 and an audio packet A#2. Further, the null packet N#5 stores the quality influence information of video packets V#4 and V#6 and audio packets A#2 and A#7. Similarly, the null packet N#10 stores the quality influence information of video packets V#9 and V#11 and audio packets A#7 and A#12. That is, the quality influence information of each of all packets excluding a video packet V#8 is stored in one of the null packets.

In the example illustrated in FIG. 21, if the packets V#6 to V#9 are lost by the packet loss, the quality influence information stored in the null packets N#5 and N#10 sandwiching the lost packets and respectively transmitted before and after the lost packets is extracted by the packet obtaining apparatus 200. As for the video, therefore, it is possible to predict that the deterioration of the reproduction quality due to the packet loss will occur in the video indicated by the quality influence information of the video packets V#6 and V#9. Further, as for the audio, it is possible to predict that the deterioration of the reproduction quality due to the packet loss will occur in the audio indicated by the quality influence information of the audio packet A#7. In other words, it is possible to obtain, in units of packet sections bordered by the null packets, the quality influence information relating to the video and audio of the packet section in which the packet loss has occurred, and to accurately estimate the deterioration of the video and audio reproduction quality in the packet section.

As described above, in the present embodiment, multiplexed data including null packets, video packets, and audio packets is transmitted, with each of the null packets storing the quality influence information of the video packet and the audio packet located immediately before the null packet and the video packet and the audio packet located immediately after the null packet. Further, the multiplexed data is obtained in the vicinity of the position at which the multiplexed data is received and reproduced, and the quality influence information is acquired from the null packet preceding the packet lost by the packet loss and the null packet following the lost packet. Accordingly, it is possible to acquire from the null packets the information relating to a portion including the lost packet, and to estimate the degree of deterioration of the reproduction quality due to the packet loss. In other words, it is possible to acquire sufficient information for estimating the quality of the video and audio reproduced by a user terminal.

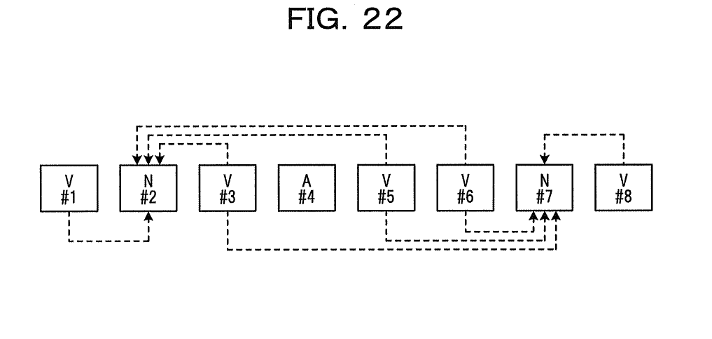

In the above-described embodiments, a null packet stores the quality influence information of the video or audio packet located immediately before the null packet and the video or audio packet located immediately after the null packet, and there are video or audio packets having the quality influence information thereof not stored in a null packet. However, it is also possible that the quality influence information of all video or audio packets located between two null packets is stored in both of the null packets. That is, as illustrated in FIG. 22, for example, it is also possible that the quality influence information of all video packets V#3, V#5, and V#6 located between null packets N#2 and N#7 is stored in both of the null packets N#2 and N#7.

In this case, in addition to the quality influence information of the video packet V#1 immediately preceding the null packet N#2 and the video packet V#3 immediately following the null packet N#2, the quality influence information of the video packets V#5 and V#6 located before the next null packet N#7 is also stored in the null packet N#2. Similarly, in addition to the quality influence information of the video packet V#6 immediately preceding the null packet N#7 and the video packet V#8 immediately following the null packet N#7, the quality influence information of the video packets V#3 and V#5 located after the previous null packet N#2 is also stored in the null packet N#7. With this configuration, if the packet loss occurs in the packet section between the null packets N#2 and N#7, for example, it is possible to acquire the quality influence information relating to all video packets included in the packet section. In FIG. 22, the quality influence information of all video packets is stored in the null packets. Similarly, the quality influence information of all audio packets can also be stored in the null packets.

With the above-described configuration, if a video or audio packet located between two null packets is lost by the packet loss, it is possible to reliably extract the quality influence information of the lost video or audio packet from the null packets. That is, even if a video or audio packet is lost, it is possible to directly acquire the information of the lost video or audio packet.

Further, in the above-described embodiments, the quality influence information extracted by the packet obtaining apparatus 200 is transmitted to the quality evaluation apparatus 10, and the quality evaluation apparatus 10 evaluates the video and audio reproduction quality. The evaluation of the video and audio reproduction quality, however, may also be performed by the packet obtaining apparatus 200. Further, the quality influence information extracted by the packet obtaining apparatus 200 may be transmitted not to the quality evaluation apparatus 10 but to the video audio transmit apparatus 100 such that the video audio transmit apparatus 100 evaluates the video and audio reproduction quality on the basis of the quality influence information.

Further, in the above-described embodiments, the quality influence information is stored in the null packets. If the video or audio packets are not encrypted, however, the quality influence information of each of the video or audio packets may also be stored in a video or audio packet located near the video or audio packet. Also in this case, the quality influence information of the video or audio packet lost by the packet loss is extracted from the video or audio packet located near the lost packet. It is therefore possible to acquire the information necessary for estimating the reproduction quality.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

What is claimed is:

1. An information acquisition system, comprising:
a transmit apparatus; and
a data obtaining apparatus;
wherein the transmit apparatus includes:
a first generation section configured to generate a first data containing video data or audio data,
a second generation section configured to generate a second data containing quality influence information of the first data, and
a transmit section configured to transmit the first data and second data to a network, and
wherein the data obtaining apparatus includes:
an obtaining section configured to obtain data units from data transmitted through the network,
a determination section configured to determine whether the first data has been lost during transmission,
a detection section configured to detect, when the determination section determines that the first data has been lost, the second data transmitted before lost first data and the second data transmitted after the lost first data, from the obtained data units, and
an extraction section configured to extract the quality influence information from the detected second data.

2. The information acquisition system according to claim 1, wherein the second generation section generates, as the second data, a unit of data not containing video data and audio data.

3. The information acquisition system according to claim 1, wherein the second generation section stores, in the second data, the quality influence information of the first data transmitted at a timing closest to the second data.

4. The information acquisition system according to claim 1, wherein the transmit apparatus further includes a multiplexing section configured to multiplex the first data and second data, and
wherein the second generation section stores, in the second data, the quality influence information of the first data multiplexed by the multiplexing section to be located immediately before or immediately after the second data.

5. The information acquisition system according to claim 4, wherein the multiplexing section arranges the second data to correct a transmission rate of the first data to a predetermined transmission rate.

6. The information acquisition system according to claim 1, wherein the second generation section generates the second data having a header portion which stores data type information and a data portion which stores quality influence parameters.

7. The information acquisition system according to claim 1, wherein the transmit section generates a transmission data having a header portion which stores a serial number and a data portion which stores a predetermined number of the first data and second data, and transmits the first data and second data in the generated transmission data.

8. The information acquisition system according to claim 1, wherein the second generation section stores, in the second data, an indicator of importance in reproduction of the video data contained in the first data and position information and motion information of the video data in a reproduced screen, as the quality influence information.

9. The information acquisition system according to claim 1, wherein the second generation section stores, in the second data, an audio level of the audio data contained in the first data, as the quality influence information.

10. The information acquisition system according to claim 1, wherein the transmit section transmits the video or audio data contained in the first data in an encrypted form.

11. The information acquisition system according to claim 1, wherein the detection section detects, from the data units obtained by the obtaining section, the second data transmitted immediately before the lost first data and the second data transmitted immediately after the lost first data.

12. The information acquisition system according to claim 1, wherein the obtaining section obtains the data units each having a header portion which stores data type information, and
wherein the detection section detects the second data by referring to the header portion of each of the data units obtained by the obtaining section.

13. The information acquisition system according to claim 1, wherein the extraction section extracts the quality influence information of the first data transmitted immediately before the second data detected by the detection section and the first data transmitted immediately after the detected second data.

14. The information acquisition system according to claim 1, wherein the extraction section extracts, from the second data, the quality influence information representing an indicator of importance in reproduction of the video data contained in the lost first data and position information and motion information of the video data in a reproduced screen.

15. The information acquisition system according to claim 1, wherein the extraction section extracts, from the second data, the quality influence information representing an audio level of the audio data contained in the lost first data.

16. The information acquisition system according to claim 1, wherein, when respective serial numbers assigned to the data units consecutively obtained by the obtaining section are not consecutive, the determination section determines that at least one data has been lost during transmission.

17. A data obtaining apparatus, comprising:
an obtaining section configured to obtain data units from data transmitted from a transmit apparatus through a network and including a first data containing video or audio data and a second data containing quality influence information of the first data;
a determination section configured to determine whether the first data has been lost during the transmission thereof;
a detection section configured to detect, when the determination section determines that the first data has been lost, the second data transmitted before the lost first data and the second data transmitted after the lost first data, from the obtained data units; and
an extraction section configured to extract the quality influence information from the detected second data.

18. A transmission method performed by a transmit apparatus, the method comprising:
generating a first data containing video data or audio data;
generating a second data containing quality influence information of the first data; and
transmitting the first data and second data to a terminal through a network.

19. A data obtaining method performed by a data obtaining apparatus, the method comprising:
obtaining data units from data transmitted from a transmit apparatus through a network and including a first data containing video data or audio data and a second data containing quality influence information of the first data;
determining whether the first data has been lost during transmission;
detecting, when the determining indicates that the first data has been lost, the second data transmitted before the lost first data and the second data transmitted after the lost first data, from the obtained data units; and
extracting the quality influence information from the detected second data.

20. The data obtaining method according to claim 19, wherein the quality of influence information is selectively used to estimate a quality of the video data and the audio data reproduced by a user terminal due to loss of the first data.
